(19) United States
(12) Patent Application Publication
(10) Pub. No.: US 2002/0101006 A1
(43) Pub. Date: Aug. 1, 2002

(54) Mould for injection-moulding a material for coating integrated circuit chips on a substrate

(75) Inventor: Christophe Prior, Le Touvet (FR)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: STMicroelectronics S.A.

(21) Appl. No.: 09/775,410

(22) Filed: Feb. 1, 2001

(51) Int. Cl. B29C 70/72

(52) U.S. Cl. 264/272.17; 425/123; 425/127

(57) ABSTRACT

An injection-molding mold having two parts adapted to take up between them the periphery of a substrate and one of which defines a molding cavity connected to means for feeding a coating material for encapsulating a row of spaced integrated circuit chips carried by a mounting face of said substrate and placed in said cavity, characterized in that the part (10) with cavities (14) includes a slot (17) for injecting the coating material into said cavity above the mounting face (2) of the substrate, recessed into its face (12) bearing on the substrate (1) along said row of chips and extending approximately the whole length of that row of chips.

The present invention relates to a mould for injection-moulding a coating material for encapsulating integrated circuit chips mounted on a substrate to form packages.

In a technique that is known in the art, a common flat substrate on which rows of integrated circuit chips are mounted and electrically connected is placed in a two-part mould, one part comprising a flat cavity surrounding the chips at a distance in order to encapsulate them in a block of coating material. The assembly is then cut up to constitute individual packages each containing one chip.

At present, the bearing face of the mould including the cavity has localised passages for injecting the coating material on one side of the rows of chips and distributed passages constituting vents for evacuating gases on the opposite side.

It has been observed that an arrangement of the above kind causes the coating material to progress heterogeneously in the cavity from the localised injection passages towards the vents, the front of the coating material being irregular, and that the pressure exerted on the coating material in the mould as it advances can damage the electrical connections of the chips to the substrate, especially when the connections are made by floating electrical wires.

An object of the present invention is to improve the conditions for injecting the coating material into the cavity of a mould so as to improve the conditions under which the coating material progresses in the cavity.

The injection-moulding mould according to the invention has two parts adapted to take up between them the periphery of a substrate and one of which defines a moulding cavity connected to means for feeding a coating material for encapsulating a row of spaced integrated circuit chips carried by a mounting face of said substrate and placed in said cavity to constitute a block of coating material embedding said chips on one side of said substrate.

In accordance with the invention, the mould part with cavities includes a slot for injecting the coating material into said cavity above the mounting face of the substrate, recessed into its face bearing on the substrate along said row of chips and extending approximately the whole length of that row of chips.

In accordance with the invention, said mould part with the cavity further includes an intermediate chamber which extends along said injection slot and which communicates with that slot over approximately all its length and the coating material passes through said chamber to be distributed over the length of said injection slot before it is injected into said cavity via said slot.

In accordance with the invention, said intermediate chamber is preferably approximately tubular.

In accordance with the invention, said intermediate chamber is preferably recessed into the face of the would part with the cavity bearing on the substrate.

In accordance with the invention, the wall of said intermediate chamber is preferably vaulted.

In accordance with the invention, the cross section of said intermediate chamber is preferably at least equal to three times the square of the thickness of said slot.

In accordance with the invention, said feed means preferably include passages for feeding said intermediate chamber distributed over its length and situated in an area opposite said injection slot.

In accordance with the invention, said cavity preferably includes a lateral hollow formed at a location far away from said opening so that said moulded block includes a projecting lateral appendix at a location far away from its periphery.

In accordance with the invention, two cavities are preferably connected by a passage so that the blocks moulded in said cavities include a projecting lateral appendix formed in said passage.

The present invention also provides an injection-moulding mould whose cavity includes a lateral hollow so that said moulded block includes a projecting lateral appendix at a location on its periphery. Two cavities can advantageously be connected by a passage so that the blocks moulded in said cavities have a projecting lateral appendix formed in said passage.

The present invention will be better understood after studying a mould for injection-moulding a coating material to encapsulate rows of integrated circuit chips on a substrate which is described by way of non-limiting example and shown in the drawings, in which:

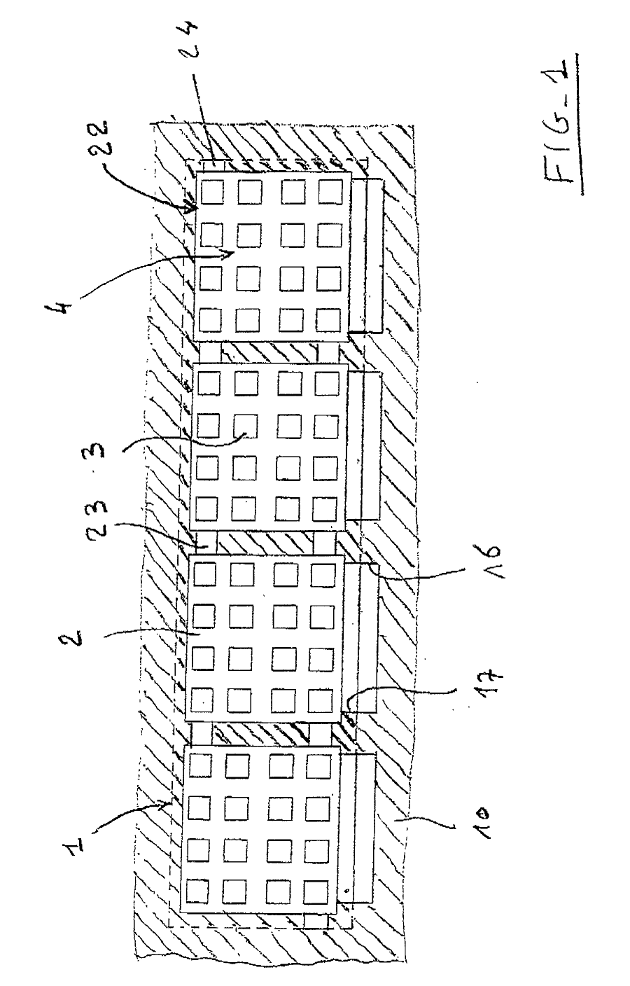

FIG. 1 is a plan view of a substrate on which rows of integrated circuit chips are mounted in accordance with a second embodiment of the invention;

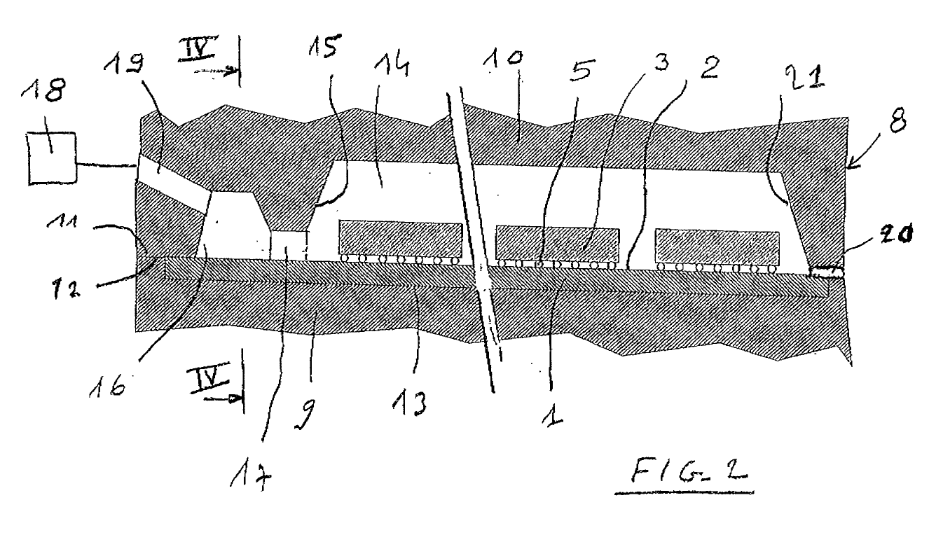

FIG. 2 is a view in cross section of an injection-moulding mould in accordance with the present invention in which the aforementioned substrate on which chips are mounted in accordance with a first embodiment of the invention has been installed;

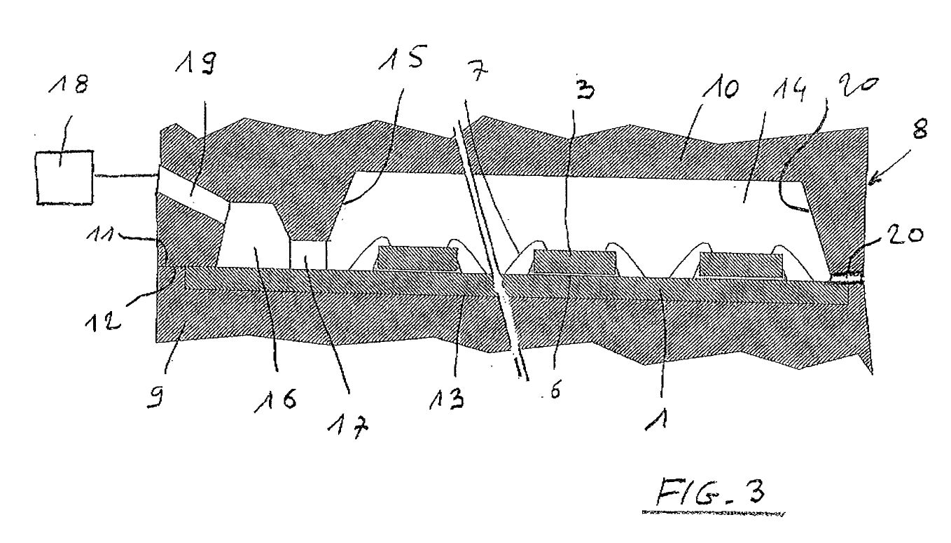

FIG. 3 shows the mould shown in FIG. 2 in which the aforementioned substrate on which chips are mounted in accordance with the second embodiment of the invention has been installed; and

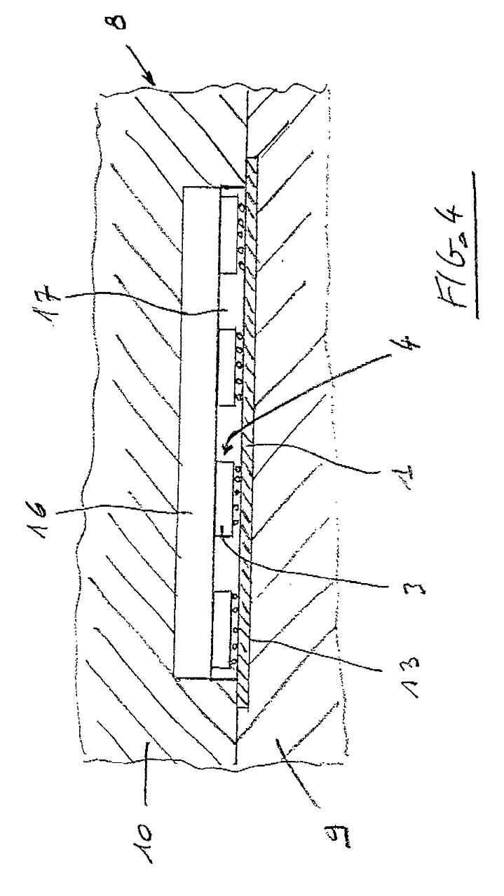

FIG. 4 is a view in longitudinal section taken along the line IV-IV of the injection-moulding mould shown in FIGS. 2 and 3.

The figures show a flat rectangular substrate 1 which has a face 2 carrying a multiplicity of printed circuit chips or dies 3.

In the example shown, and in a manner that is known in the art, the chips 3 are grouped to form four packets 4 spaced and distributed along the length of the substrate 1, each packet including a matrix of sixteen spaced chips arranged to form longitudinal rows and transverse rows.

In the example shown in FIG. 2, the chips 3 are fixed to the mounting face 2 of the substrate 1 and electrically connected to the substrate by conductive balls 5.

In the example shown in FIG. 3 the chips 3 are glued to the mounting face 2 of the substrate 1 by a layer of glue 6 and are electrically connected to the substrate 1 by floating conductive wires 7.

The substrate 1 includes an integrated electrical connection network, not shown. This is known in the art.

FIGS. 2 and 3 show an injection-moulding mould 8 which includes a lower part 9 and an upper part 10 adapted to bear one against the other and which have bearing surfaces 11 and 12 for this purpose.

The lower part 9 includes a cavity 13 recessed into its bearing face 11 and sized to receive flat the substrate 1 fitted with the chips 3 with the chips uppermost.

The upper part 10 of the mould 8 has four flat cavities 14 recessed into its bearing face 12 whose shapes are such that when the upper part 10 of the mould 8 bears on its lower part 9 the cavities 14 define injection chambers surrounding the packets 4 of chips 3 at a distance and the bearing face 12 of the upper part 10 of the mould 1 bears on the peripheral area of the mounting face 2 of the substrate 1 and between the packets 4 of the chips 3.

Four spaced longitudinal and approximately tubular chambers 16 having a vaulted profile in section are recessed into the bearing face 12 at a relatively small distance from the longitudinal wall 15 of the cavity 14, which runs alongside and at a distance from an edge longitudinal row of packets 4, each chamber 16 extending in the area of each cavity 14.

The upper part 10 of the mould 8 has four slots 17 recessed into its bearing face 12 between the chambers 16 and the cavities 14 to constitute four slots of constant thickness which extend approximately the length of the rows of chips 3 of the respective packets 4. The length of the chamber 16 is preferably equal to the length of the slots 17.

In one embodiment, the chambers 16 and the slots 17 extend the whole length of the cavities 14.

The intermediate chambers 16 are connected to a device 18 for feeding a coating material, shown diagrammatically in the drawing, the upper part 10 of the mould 8 having for this purpose a multiplicity of transverse passages 19 opening into the chambers 16 on the side opposite the injection slots 17.

Opposite the slots 17 the upper part 10 of the mould 8 has vents 19 for evacuating gases, not shown, formed in its wall 21 opposite its wall 15.

In one particular embodiment the thickness of the chips is from 100 to 400 microns and the thickness of the cavities 14 is from 0.2 to 0.8 mm.

In this case, the thickness of the injection slots 17 can be from 0.1 to 0.3 mm, their width can be from 0.5 to 1 mm, and the height and the width of the chambers 17 can be from twice to five times the thickness of the slots 17. The cross section of the chambers 16 is preferably at least three times the square of the thickness of the injection slots 17.

Because of the structure of the injection-moulding mould 8 described hereinabove, the coating material ted under pressure by the feed device 18 enters the chambers 16 via the passages 19, is mixed in the chambers to homogenize it, and is injected into the cavities 14 via the injection slots 17. The injected material progressively fills the cavities 14 and forms layers which progress regularly towards the face 20 of the cavities 14 opposite their face 15.

Because the chambers 16 and the injection slots 17 respectively extend approximately the length of the rows of chips 3 of the packets 4, the coating material progresses regularly in the cavities 14, across their entire width, the front of the layer of coating material as it progresses being substantially regular and its rate of progression being compatible in particular with the hardening characteristics of the coating material.

Accordingly, the fixing and electrical connecting means of the chips 3, in particular the metal wires 7, are subject to acceptable stresses and there is no risk of them being damaged or torn away.

At the end of the injection-moulding operation, the groups 4 of chips 3 are embedded in parallelepiped-shaped blocks 22 on the substrate 1.

FIG. 1 shows that the upper part 10 of the mould 8 has two recessed parts 23 which laterally join two adjacent cavities 14 and recessed parts 24 which are formed laterally at the ends of the edge cavities 14.

The blocks 22 obtained after injection-moulding therefore include laterally projecting appendices or wings on which ejectors can bear to remove them from the mould. The ejectors therefore leave no traces on the blocks 22 that contain the chips 3.

The present invention is not limited to the embodiments described hereinabove. Many variants are possible without departing from the scope of the invention as defined by the appended claims.

What is claimed is:

1. An injection-molding mold comprising:
first and second parts formed to hold therebetween the periphery of a substrate having a mounting face that carries at least one row of spaced integrated circuit chips,
wherein the first part of the mold defines a molding cavity for receiving a coating material for encapsulating the row of spaced integrated circuit chips, so as to form a block of coating material that embeds the chips on one side of the substrate, and
the first part of the mold includes an injection slot through which the coating material is injected into the cavity above the mounting face of the substrate, the injection slot being recessed into the face of the first part bearing on the substrate along the row of circuit chips, and extending substantially the length of the row of chips.

2. The mold as defined in claim 1, wherein the first part of the mold further includes an intermediate chamber that extends along the injection slot, the intermediate chamber communicating with the injection slot over substantially its entire length such that the coating material passes through the intermediate chamber and is distributed over the length of the injection slot before being injected into the cavity via the injection slot.

3. The mold as defined in claim 2, wherein the intermediate chamber is substantially tubular.

4. The mold as defined in claim 2, wherein the intermediate chamber is recessed into the face of the first part of the mold bearing on the substrate.

5. The mold as defined in claim 4, wherein at least one wall of the intermediate chamber is vaulted.

6. The mold as defined in claim 2, wherein the cross section of the intermediate chamber is at least equal to three times the square of the thickness of the injection slot.

7. The mold as defined in claim 2, further comprising:
passages for feeding the coating material into the intermediate chamber,
wherein the passages are distributed over the length of the intermediate chamber and situated opposite the injection slot.

8. The mold as defined in claim 1, wherein the cavity includes a lateral hollow formed at a location some distance away from the injection slot so that the block of coating material includes a projecting lateral appendix at a location on its periphery.

9. The mold as defined in claim 1,
wherein the first part of the mold defines at least two molding cavities, and
the two cavities are connected by a passage so that the blocks of coating material molded in the cavities include a projecting lateral appendix formed in the passage.

10. An injection-molding mold comprising:
first and second parts formed to hold therebetween the periphery of a substrate having a mounting face that carries at least one row of spaced integrated circuit chips,
wherein the first part of the mold defines a molding cavity for receiving a coating material for encapsulating the row of spaced integrated circuit chips, so as to form a block of coating material that embeds the chips on one side of the substrate, and
the cavity includes a lateral hollow so that the block of coating material includes a projecting lateral appendix at a location on its periphery.

11. The mold as defined in claim 10,
wherein the first part of the mold defines at least two molding cavities, and
the two cavities are connected by a passage so that the blocks of coating material molded in the cavities include a projecting lateral appendix formed in the passage.

12. A method for injection-molding, said method comprising the steps of:
placing a substrate in an injection mold, the substrate having a mounting face that carries at least one row of spaced integrated circuit chips; and
supplying a coating material into a cavity in the mold so as to encapsulate the row of circuit chips in a block of coating material on one side of the substrate,
wherein the supplying step includes the sub-step of injecting the coating material into the cavity through an injection slot located above the mounting face of the substrate, the injection slot being recessed into a face of the mold along the row of circuit chips and extending substantially the length of the row of chips.

13. The method as defined in claim 12, wherein the supplying step further includes the sub-step of supplying the coating material into an intermediate chamber such that the coating material passes through the intermediate chamber and is distributed over the length of the injection slot before being injected into the cavity via the injection slot.

14. The method as defined in claim 13, wherein the intermediate chamber extends along the injection slot so as to communicate with the injection slot over substantially its entire length.

15. The method as defined in claim 13, wherein the cross section of the intermediate chamber is at least equal to three times the square of the thickness of the injection slot.

16. The method as defined in claim 13, wherein the supplying step further includes the sub-step of supplying the coating material into passages that feed the coating material into the intermediate chamber, the passages being situated opposite the injection slot.

17. The method as defined in claim 12, further comprising the step of providing the cavity with at least one lateral so that the block of coating material includes a projecting lateral appendix at a location on its periphery.
